(19) United States
(12) Patent Application Publication
(10) Pub. No.: US 2025/0247663 A1
(43) Pub. Date: Jul. 31, 2025

(54) HRTF Partitioning for Re-Synthesis

(71) Applicant: Sony Interactive Entertainment Inc., Tokyo (JP)

(72) Inventors: Calum Armstrong, London (GB); Danjeli Schembri, London (GB)

(73) Assignee: Sony Interactive Entertainment Inc., Tokyo (JP)

(21) Appl. No.: 19/040,132

(22) Filed: Jan. 29, 2025

(30) Foreign Application Priority Data
Jan. 29, 2024 (GB) 2401107.4

(51) Int. Cl. H04S 7/00

(52) U.S. Cl. CPC H04S 7/302; H04S 2400/11; H04S 2420/01

(57) ABSTRACT

A computer-implemented method of synthesising an HRTF is disclosed. The method comprising: providing the HRTF of a subject measured at a particular measurement angle; processing the HRTF to remove localisation perception features of the HRTF, where the processing comprises: removing spectral notches from the measured HRTF, the resulting processed HRTF referred to as the HRTF'; and calculating a subject's HRTF timbre by subtracting a baseline HRTF at the measurement angle from the subject's HRTF', the baseline HRTF comprising a generalised response component such that the HRTF timbre comprises subject-specific variations in the HRTF. The method further comprises using the HRTF timbre to synthesise an HRTF. The method allows for generating a personalised timbre component of an HRTF to provide better personalisation of an HRTF, thereby providing improved binaural audio.

### CROSS-REFERENCE TO RELATED APPLICATIONS

The present application claims priority from United Kingdom Patent Application No. GB 2401107.4, filed Jan. 29, 2024, the disclosure of which is hereby incorporated herein by reference.

### FIELD OF THE INVETION

The following disclosure relates to methods and systems for synthesising an HRFT, particularly for use in improved binaural audio for VR, AR and video gaming applications.

### BACKGROUND

Binaural audio is a crucial component of the rapidly developing immersive technologies, such as VR, AR and video gaming applications. Spatial audio, and specifically Head-Related Transfer Function (HRTF) personalisation, plays a vital role in a user's experience of virtual and augmented environments. It is necessary to precisely tune the audio experienced by the user to provide the necessary spatial audio effects to provide an immersive experience.

Head-Related Transfer Functions (HRTFs) are frequency and time-dependent signal processing filters that represent the stereo anechoic acoustic transfer function between a positional sound source and a listener's ears. HRTFs describe the way in which a person hears sound in 3D depending on the position of the sound source. HRTFs therefore provide the listener with spatial cues that help them to localize sounds in 3D space. These cues include time and level differences between ears (primarily associated with lateral localization) and peaks/notches within the frequency response of each ear (primarily associated with elevatory localization). By convolving an audio signal with an HRTF and presenting the result directly to a listener's ears (usually via headphones), a source may be simulated as if coming from the direction in which the HRTF was measured.

Given the importance of HRTFs in simulating immersive acoustic experiences in augmented reality (AR), virtual reality (VR), and gaming applications, there has been significant work focussing on synthesising personalised HRTFs for use in these applications. Multiple methods have been proposed for HRTF personalisation, including estimation given anthropometric features, simulation given the 3D geometry of a subject's ear or personalisation based on perceptual feedback. These personalised HRTFs may then be applied to an input audio signal to provide an approximation to the way a specific user experiences audio.

Despite progress, there are a number of issues with known methods for HRTF synthesis and personalisation. Algorithms for calculating, synthesising and applying HRTFs care often complex and not well suited for runtime application, for example in the context of synthesising an HRTF for a user of a video gaming system at runtime. There are also issues with storing a large number of different HRTFs or data for synthesising HRTFs, both in terms of memory requirements and also needing to validate all HRTFs to ensure no errors occur when using the HRTFs at runtime. These issues further limit the applicability of these methods for runtime implementation.

There is accordingly a need for new HRTF synthesis and personalisation methods that make progress in overcoming the above issues.

### SUMMARY OF INVENTION

According to a first aspect, the present disclosure provides a computer-implemented method of synthesising a head related transfer function, HRTF, the method comprising: storing a plurality of sets of partial HRTFs, a partial HRTF comprising an HRTF with a sub-selection of the total features of a full HRTF, wherein each set of partial HRTFs comprises variations in a different feature of an HRTF; selecting a partial HRTF from each set of partial HRTFs; combining the selected partial HRTFs to synthesise a HRTF.

Combining the partial HRTFs refers to combining the partial HRTFs with each other. By storing sets of partial HRTFs that each comprise variations in a different feature of an HRTF, it is possible to synthesise a HRTF having selected values of the individual features of the partial HRTFs by combining a partial HRTF selected from each set. This provides a much more computationally efficiency and robust method of generating a “full” HRTF than prior art methods of HRTF synthesis and personalisation, which often require algorithms for individually generating and tuning individual HRTF features in order to synthesise an HRTF. In this way, the present method is much more suitable for synthesising HRTFs at runtime, for example when generating a personalised HRTF for a user of a video gaming system. In particular, because the partial HRTFs are pre-rendered and stored, there is no requirement to build or generate the HRTF other than simply combining the partial HRTFs. Furthermore, the method provides a high degree of variation and tunability with a comparatively limited amount of stored data. For example, storing 3 sets of partial HRTFs, each with 10 variations of a particular property, means the equivalent of only 30 partial HRTFs need be stored but 1000 individual HRTFs can be generated, based on all possible combinations of the partial HRTFs. Since all synthesised HRTFs are built from a limited number of partial HRTFs, only this limited number of files need to be validated for use, reducing the likelihood of errors compared to methods involving synthesising individual bespoke HRTF features or full HRTFs at run time.

A full HRTF does not necessarily include every possible HRTF feature that is associated with the perception of the elevatory and lateral location of a sound source, but refers to an HRTF that includes: one or more features of the HRTF associated with the perception of the elevator location of a sound source, one or more features of the HRTF associated with the perception of the lateral location of a sound source. In this way, when the full HRTF is applied to an input audio signal, the resulting filtered audio signal provides high accuracy externalisation and localisation. A full HRTF may also include one or more features of the HRTF associated with the timbre of a sound.

A feature of an HRTF may be defined as individual aspect or property of the HRTF, such as morphological features of the HRTF. These may include shape of the frequency response curve in a region of the HRTF, for example relating to a maxima, minima, gradient or other property defining a shape of the graph. Preferably the features comprise HRTF features responsible for significant aspects of user-perception of a sound generated using the HRTF, such as localisation perception. The features may comprise the size and position of a peak or trough or features relating to the differences between the left and right ear HRTFs.

Each partial HRTF may comprise the same number of samples as the HRTF to be synthesised. In some examples, the partial HRTFs may be stored with fewer samples than the HRTF to be synthesised, in order to compress the data. The partial HRTFs may be augmented to the required sample size to combine and generate the synthesised HRTF. A partial HRTF may equally be defined as an “HRTF partition”, since it comprises part of a full HRTF.

Preferably the variations in the feature across a set of partial HRTFs provides variations in a user perceived property of a sound, with each set of partial HRTFs providing variations in a different user perceived property of a sound. A user-perceived property of a sound preferably comprises a discernible characteristic of a sound generated by a virtual sound source. By configuring the sets of partial HRTFs such that each set provides variations in a different user perceived property of a sound, it is possible to make a selection of a value or attribute of each user perceived property by the selection of the corresponding partial HRTF. By combining the partial HRTFs to synthesis an HRTF, the synthesised HRTF will provide the selected attribute of each user perceived property. The varied features of each set are preferably separable and independently variable. In this way, varying the features of one set only influences the user perceived property of that set.

Preferably the method is applied to synthesis an HRTF at run-time of a video gaming system, the method comprising: storing the plurality of sets of partial HRTFs in a memory of a video gaming system; at runtime, selecting the partial HRTFs and combining to synthesise the HRTF; and applying the synthesised HRTF generate binaural audio during gameplay of a video gaming system.

Since the process of combining partial HRTFs, for example by convolution, requires relatively little processing capacity compared to generating bespoke features, the present method is particularly advantageous for deployment at run time of a video gaming system, or equally a VR or AR system. In particular, the method is computationally efficient and the user will experience very little delay while the HRTF is synthesised. It also requires relatively little memory since all HRTFs are constructed from a limited number of partial HRTFs.

Preferably, together the combined partial HRTFs selected from each set provide all features of a full HRTF, such that combining selected partial HRTFs synthesises a full HRTF. Alternatively stated, the features of a full or complete HRTF are divided between the sets of partial HRTFs, with the partial HRTFs of each set of partial HRTFs having different variants of the features of that set. In this way the method can be used to synthesise a full HRTF.

Preferably one or more set of partial HRTFs corresponds to a variations in a parameter associated with a perceived location of a sound source. There are known “localisation” features of HRTFs that are primarily responsible for the perceived location of a sound source. Preferably the sets of HRTFs comprise variations in different localisation features. Parameters of an HRTF refer to the value of a feature of the HRTF, such as an amplitude of a component audio filter in the HRTF, a Boolean existence of a feature, a frequency value, a width of a notch, etc.

Preferably the plurality of sets of partial HRTF comprise: a first set of partial HRTFs comprising variations in one or more features of the HRTF associated with the perception of the elevatory location of a sound source; and a second set of partial HRTFs comprising variations in one or more features of the HRTF associated with the perception of the lateral location of a sound source. Since a user's physiological features define the specific form of the features of their HRTF responsible for elevatory and lateral localisation perception, it is desirable to be able to tune elevatory and lateral perception separately. Separating the respective HRTF features responsible for these two properties of localisation perception into separate partial HRTF sets achieves this.

Preferably the first set of partial HRTFs comprise variations in one or more of: a parameter of a pinnae notch, a parameter associated with contralateral and ipsilateral frequency filtering; and the second set of partial HRTFs comprise variations in one or both of: the interaural time delay and the interaural level difference. In this way, the primary features responsible for elevatory and lateral perception are separably tunable by selection from the respective partial HRTF sets. Preferably the first set of partial HRTFs comprise variations in a parameter of defining the size or position of the first pinnae notch.

Preferably the first set and second sets of partial HRTFs comprise HRTF data for a single ear only, wherein the method comprises: after selecting the partial HRTFs from the first and second set, copying the selected partial HRTFs and using the selected partial HRTFs to provide HRTF data for the second ear. Since there is an inherent symmetry in the HRTF data for the left and right ear, the data may be compressed by storing the response of one ear only and then, at run time, copying the data and using the data for the second ear to provide stereo HRTF data. The method preferably involves adjusting the measurement angle of the first ear HRTF data to provide corresponding data for the second ear. The adjustment of the measurement angle preferably comprises adjusting the azimuthal measurement angle. This may be referred to as “flipping” or “reversing” the copied HRTF data for the first ear to provide HRTF data for the second ear. Preferably the method comprises reflecting the azimuthal angle across the median (i.e. longitudinal) plane of the listener. In this way, where the azimuthal angle is measured clockwise with 0° directly ahead of a listener, a right ear azimuthal angle of 45° becomes a left ear angle of −45° (or 315°).

Preferably the method comprises selecting a partial HRTF from the first and second set; combining the partial HRTFs selected from the first and second set; adjusting the azimuthal angle of the combined HRTFs to synthesise an HRTF for the second ear. By combining the selected partial HRTFs before copying and adjusting the measurement angle to provide the second ear data, only one set of convolutions need be performed, improving the computation efficiency. In some examples, different partial HRTFs may be used for each ear. For example, a first selection of partial HRTFs from the first set and second set may be made for the first ear and a second selection of partial HRTFs from the first and second set may be made for the second ear, where the first and second selections differ. In this case the first selection of partial HRTF is combined to synthesise the HRTF for the first ear and the second selection of partial HRTFs is combined and then reversed to synthesise the HRTF for the second ear. In this way, a non-symeetrical HRTF may be synthesised in which the properties differ for the first and second ears.

The method may further comprise storing metadata data defining additions or modifications to be made to the second ear data after copying from the first ear data to provide an even closer approximation. Preferably one or more of the sets of partial HRTFs comprises HRTF data for a single car and the meta data comprises phase information, preferably ITD data.

Preferably a set of partial HRTFs comprises variations in one or more features of the HRTF associated with the timbre of a sound. This set of partial HRTFs may be defined as the “timbre set” of partial HRTFs. The partial HRTFs of this set preferably comprise a timbral component of an HRTF. The timbral component encodes frequency dependent magnitude changes on an audio signal that do not primarily provide the location cues in the HRTF but provide characteristic changes to an audio signal specific to the subject. The timbral component is characterised by smoothly varying low magnitude changes, for examples changes of less than 10 dB.

The partial HRTFs of the timbre set of partial HRTFs each comprise an HRTF with the localisation perception features of the HRTF removed. These partial HRTFs may be referred to as the HRTF timbre and, although they do not comprise localisation perception features of the HRTF, they are can be combined with other HRTFs to synthesise an HRTF with adjusted timbral and localisation components. The HRTF may be obtained from a measured HRTF by: providing the HRTF of a subject; processing the HRTF to remove localisation perception features of the HRTF, where the processing comprises: removing spectral notches from the measured HRTF, the resulting processed HRTF referred to as the HRTF'; and calculating a subject's HRTF timbre by subtracting a baseline HRTF from the subject's HRTF' such that the HRTF timbre comprises subject-specific variations in the HRTF.

Preferably, removing spectral notches comprises removing pinnae notches from the HRTF. The pinnae notches provide a significant component of the localisation perception information in an HRTF so removing them leaves timbral changes in the resulting processed spectrum.

Preferably removing spectral notches comprises identifying notch boundaries; removing samples within the notch boundaries; re-interpolating the HRTF measurement between the notch boundaries. In this way, the notches are removed but a complete transfer function is retained, preserving the shape of the underlying spectrum.

Preferably a set of partial HRTFs comprise one or more features that are varied across the set to provide the variations in a user perceived property of a sound, wherein each of the partial HRTFs of one of the sets of partial HRTFs additionally comprises a baseline HRTF. The baseline HRTF preferably comprises a baseline that the features of the partial HRTFs are defined relative to. The baseline HRTF may therefore be combined with the features of the partial HRTFs to form the full HRTF. By including the baseline HRTF in one of the sets of partial HRTFs it is not necessary to store a separate baseline HRTF and therefore provides better storage efficiency. The baseline HRTF may comprise a component of an average HRTF with user-specific perception related features removed. In this way, it may be considered an average response, which the features of the partial HRTFs are defined relative to.

The method preferably comprises selecting a partial HRTF from each set of partial HRTFs at runtime, and performing a convolution of the partial HRTFs to combine them to form the full HRTF. A convolution provides a computationally efficient means of combining the features of the individual partial HRTFs into the final synthesised HRTF.

Preferably the method comprises storing each partial HRTF as head related impulse response, HRIR, data in the time domain. Time domain format requires only real data, rather than complex frequency data, and therefore requires a reduced number of samples to save the data.

The method preferably comprises storing each partial HRTF as a minimum phase filter in the time domain, and truncating trailing zeros from each minimum phase filter. This allows the possibility of using a very short filter length (the number of samples per HRTF-or equivalently HRIR in the time domain) with minimal loss in quality.

Preferably combining the selected partial HRTFs comprises performing a multi-way convolution. In some examples the method comprises converting the HRIR data into the frequency domain and multiplying each partial HRTF together. The synthesised HRTF may be applied in the frequency domain or can be converted back to the time domain by performing an inverse FFT. In examples where the data for only one ear is stored, the method preferably first comprises constructing the partial HRTF for both ears by copying the stored data for one ear and adjusting the measurement angle of the filters to provide the data for the second ear. In one example, partial HRTF data for a single ear is stored, and the method comprises selecting a partial HRTF from each set, performing a convolution to combine the selected partial HRTFs and subsequently adjusting the associated measurement angle of the filters forming the partial HRTF data. Assuming a symmetry between the right and left ear data, this adjustment involves reflecting the azimuthal angle in the median plane of the listener to provide the synthesised HRTF for the second ear. By performing the convolution prior to “flipping” the data, the flipping of data only needs to be performed once, rather than for each separate partial HRTF. In other examples, one or more of the sets of partial HRTF may comprise stereo data, comprising HRTF data for each ear. In this case, only the sets of partial HRTS data comprising single ear data are copied and adjusted to provide the second ear data.

Preferably selecting a partial HRTF from each set of partial HRTFs comprises: receiving a user input and performing the selection based on the user input. In this way a user can select, at runtime, the combination of partial HRTFs to provide optimum results.

In some examples the method comprises receiving user input of measurement data encoding a measurement of at least part of the user's HRTF and selecting the partial HRTFs based on the measurement data. By inputting some data indicative of the user's required HRTF, the partial HRTFs may be selected to provide the most suitable combination. In some examples the measurement data may comprise a measurement of part of the HRTF. For example, the user may be guided through a calibration routine to record one or more measurements that may be used to select the partial HRTFs. The measurement may include recording a sound output from a loudspeaker using a microphone of a user device, for example positioned near the user's ear.

In some examples selecting the partial HRTFs comprises: receiving user physiological data and selecting the partial HRTFs based on the received user physiological data; wherein physiological data comprises one or more of: data encoding measurements of the user's head size or shape; data encoding measurements of the user's shoulder size or shape; data encoding measurements of the user's torso size or shape; data encoding measurements of the user's ear size or shape; an image of the subject's ears. In this way, the user's HRTF can be predicted based on the physiological data, and partial HRTFs selected that best match the predicted HRTF. In some examples, selecting the partial HRTFs based on the received user physiological data comprises: inputting the physiological data into a machine learning model trained to map the input physiological data to a stored partial HRTF.

In another aspect of the invention there is provided a computer program comprising instructions that, when executed by a computer, cause the computer to perform a method according to any preceding claim.

In another aspect of the system there is provided video gaming system comprising: a memory storing a plurality of sets of partial HRTFs, a partial HRTF comprising an HRTF with a sub-selection of the total features of a full HRTF, wherein each set of partial HRTFs comprises variations in a different feature of an HRTF; and a processor configured to: select a partial HRTF from each set of partial HRTFs; combine the selected partial HRTF to synthesise a HRTF; apply the synthesised HRTF to generate binaural audio.

### BRIEF DESCRIPTION OF DRAWINGS

Embodiments of the invention are described below, by way of example only, with reference to the accompanying drawings, in which:

FIG. 1 illustrates a a method of synthesising a head-related transfer function according to the present invention;

FIG. 2 illustrates the definition of lateral and elevatory displacement of a sound source relative to a user;

FIG. 3 illustrates a method of synthesising a head-related transfer function according to the present invention;

FIG. 4 illustrates a method of combining stored partial for synthesising a head-related transfer function according to the present invention.

### DETAILED DESCRIPTION

Head-Related Transfer Functions (HRTFs) are frequency and time-dependent signal processing filters that represent the stereo anechoic acoustic transfer function between a positional sound source and a listener's ears. In the time domain, they are referred to as Head-Related Impulse Responses (HRIRs). An individual's HRTF is commonly measured at many angles around their head, referenced with respect to azimuth (rotation around the horizontal axis) and elevation. The response of left and right ears differ and are both encoded into the full HRTF.

HRTFs provide the listener with spatial cues that help them to localize sounds in 3D space. These cues include time and level differences between ears (primarily associated with lateral localization) and peaks/notches within the frequency response of each ear (primarily associated with elevatory localization). By convolving an audio signal with an HRTF and presenting the result directly to a listener's ears (usually via headphones but also potentially via loud speakers with additional signal processing considerations), a source may be simulated as if coming from the direction in which the HRTF was measured. HRTFs are a crucial part of binaural acoustic applications for simulating immersive acoustic experiences in augmented reality (AR), virtual reality (VR), gaming and entertainment applications.

Since each individual has a unique HRTF, in order to provide accurate binaural audio in applications such as video games it is necessary to carefully select an HRTF to ensure it is as close as possible to user's true HRTF. To achieve this it is necessary to simulate a personalised HRTF to be applied to output audio signals. Many methods have been explored for this, such as adjusting known features in an input HRTF or creating individual HRTF features to be added to a baseline HRTF, for example based on predicting the required form of the HRTF features, such as notch positions, based on user feedback or on input physiological features of the user (such as on measurements of the head and ear or an image of the user's ear).

These methods generally attempt to calculate and apply individual prominent known features in the HRTF that are responsible for the majority of localisation perception. These include the interaural time delay (ITD), related to the size and shape of the user's head and the distance between the user's ears and the interaural level distance (ILD) related to the differing frequency-dependent sound sensitivity between a user's ears, the ITD and ILD primarily associated with lateral localisation. The features further include the spectral notches, or “pinnae notches”, related to the user's pinna features of the ear, which are primarily responsible for elevation localisation.

The algorithms for calculating, synthesising and applying individual HRTF features are complex, requiring significant computation and memory resources and are often subject to unanticipated errors associated with calculating and applying bespoke features. This makes these known techniques of HRTF synthesis challenging to apply at run time, for example when synthesising a personalised HRTF for a user of video game system to be applied during use of the system. The present method proposes a new solution based on combining pre-calculated “partial HRTFs”, each encoding a specific “hearing factor” or property/attribute of user-perception of a sound, so as to provide a HRTF including each of the features of the individual partial HRTFs.

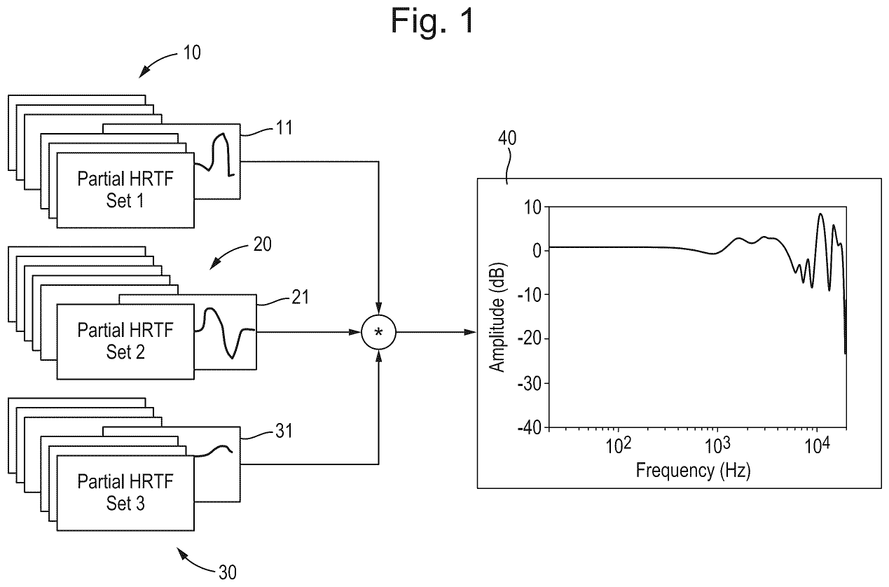

FIG. 1 schematically illustrates the method of the present invention, which involves storing a plurality of sets of partial HRTF 10, 20, 30 wherein each set of partial HRTFs 10, 20, 30 comprises variations in a different feature of an HRTF to provide a respective variation in a different user-perceived property of a sound; selecting a partial HRTF 11, 21, 31 from each set of partial HRTFs 10, 20, 30 and combining the selected partial HRTFs 11, 21, 31 to synthesise a full HRTF 40. In this way, the full HRTF includes the selected variation of the features of each partial HRTF. The synthesised HRTF 40 may then be applied to an output audio signal to generate binaural, 3D audio.

The sets of partial HRTF each correspond to variations in a different user perceived property of a sound (i.e. from a virtual sound source at a particular location). These are preferably individual, separable properties of a perceived sound that can be varied independently. For example, in a preferable implementation, one set of partial HRTFs comprise variations in perception of the elevatory location of a sound source (i.e. the perceived height of a sound source relative to a user) and a second set of partial HRTFs comprises variations in perception of the lateral location of a sound source (i.e. the perceived lateral location relative to the user). The features primarily responsible for these two perceptual attributes differ and therefore they can be divided into separate partial HRTFs. By providing partial HRTF with different versions of these features, the two perceptual properties can be tuned by selection of appropriate partial HRTFs.

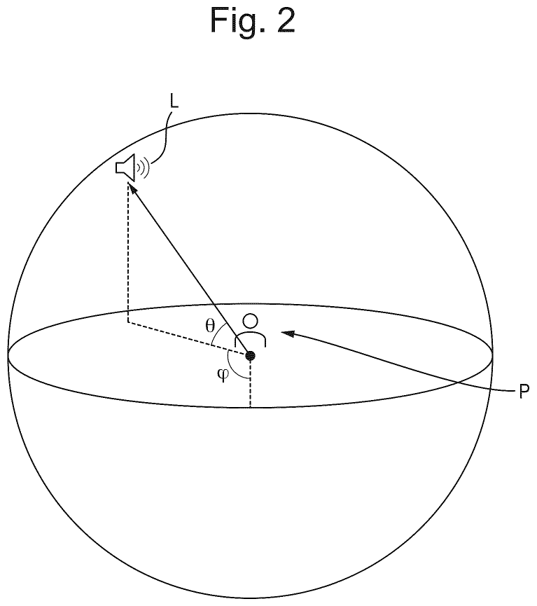

The location L of a sound source can be defined in three dimensions (e.g. range r, azimuth angle θ and elevation angle φ), as shown in FIG. 2 and the HRTF can be modelled as a function of three-dimensional position of the sound source relative to the user location P. The lateralisation (or “width”) of the sound source refers to the azimuthal sound direction, while the elevation of the sound source refers to the elevation (or “height”) direction. There are separate specific features of the HRTF that contribute to the perceived lateralisation and the perceived elevation of the sound source.

For example, the location of the first pinna notch (FPN) in the HRTF affects the perceived elevation of the sound source. This is a feature of an HRTF that varies from user to user and is based on the shape of the user's outer ear (pinna). The pinna features are contours of the ear shape which affect how sound waves are directed to the auditory canal. The length and shape of the pinna features affect which sound wavelengths are resonant or antiresonant with the pinna feature, and this response also typically depends on the position and direction of the sound source. The creation of these one or more resonances or antiresonances appear in the HRTF as spectral peaks or notches.

Moreover, the interaural time delay (ITD) is a first feature predominantly affecting the perceived lateralisation of the sound source. The distance between the user's ears (also referred to as the “head width”) causes a delay between sound arriving at one ear and the same sound arriving at the other ear, resulting in the interaural time delay. Other head measurements can also be relevant to hearing and specifically relevant to ITD, including head circumference, head depth and/or head height.

A second HRTF feature that predominantly affects the perceived lateralisation of the sound source is the interaural level difference (ILD). The ILD arises due to the difference in intensity and frequency distributions of the sound received from the sound source by each ear. The ear closest to the sound source will detect a louder sound than the ear furthest away from the sound source due to dissipation of the sound as the sound wave travels.

The above-mentioned HRTF features affect the perceived position of a sound source and therefore one or more may be manipulated to alter this perceived position of the sound source. Furthermore, these features may be varied independently to vary the perceived lateral position of a sound source independently of the elevatory position, and vice versa.

HRTF features affecting the perception of a sound source are not limited to those mentioned above and may additionally comprise other features, for example, a second or subsequent pinnae notch, and lower magnitude changes associated with the timbre of a perceived sound, as described in further detailed below. The method of the present invention may be extended to any features of an HRTF, that may be divided into partial HRTFs.

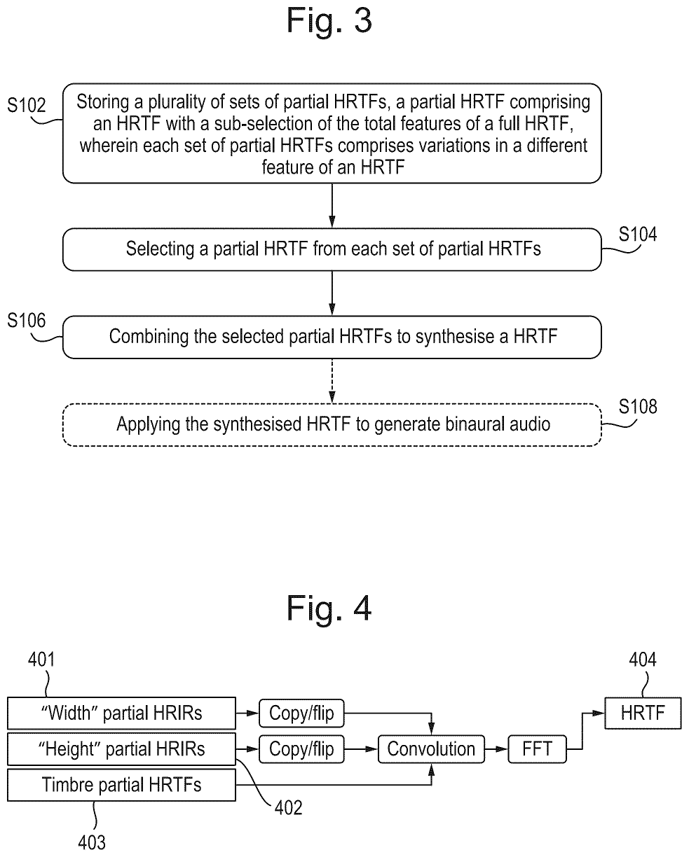

FIG. 3 illustrates a flow diagram for the method of the present invention. The method involves a first step S102 of storing a plurality of sets of partial HRTFs, a partial HRTF comprising an HRTF with a sub-selection of the total features of a full HRTF, wherein each set of partial HRTFs comprises variations in a different feature of an HRTF; a second step S104 of selecting a partial HRTF from each set of partial HRTFs; and a third step S106 of combining the selected partial HRTFs to synthesise a HRTF. The method may end after step S106, with the synthesised HRTF ready for use when required. The method may then proceed to step S108: applying the synthesised HRTF to generate binaural audio.

Previous methods of HRTF synthesis and personalisation have generally attempted to synthesise these HRTF features at run time to provide the required localisation effects for a user. The present method departs from this principle by pre-synthesising a plurality of variations of important features, storing these and combining them at run-time to create HRTFs based on combinations of selected features (as included in the partial HRTFs). Since the features responsible for variation in a particular user-perceive property (such as the elevatory position of a sound source, the lateral position of a sound source, and the timbre of a sound source) may be independently varied to provide corresponding variations in the user-perceived property, partial HRTFs providing the variations in each property may be pre-calculated and stored for combination at runtime. A “full HRTF” may be constructed simply by combining the partial HRTFs, for example selecting a required variation of the lateral perception, or “Width”, partial HRTF, a required variation of the elevatory perception, or “Height”, partial HRTF and a required variation of the timbre HRTF. This allows a large number of full HRTFs to be generated at run time, based on a relatively small number of partial HRTFs. For example, 10 variations of each of the Height, Width and Timbre partial HRTFs allows for 1000 possible full HRTFs to be generated at runtime, based on data equivalent to 30 HRTFs (i.e. each of the partial HRTFs comprises approximately the same number of samples and therefore a similar data size to a single HRTF).

In one specific example the sets of partial HRTFs may be defined as follows:
1. Height partial HRTFs providing variations in features relating to user perception of the elevatory location of a sound source, including one or more of the following features:
   a. One or more pinnae notches, that may each be defined by parameters such as centre frequency, width and height of the notch
   b. Contralateral and ipsilateral frequency filtering/shelving;
2. Width partial HRTFs providing variations in features relating to user perception of the lateral location of a sound source, including one or more of the following features:
   a. Interaural time delay (ITD)
   b. Interaural level difference (ILD)
3. Timbre partial HRTFs providing variations in features relating to user perception of the timbre of a sound received from a sound source, including one or more of the following features:
   a. Frequency dependent magnitude changes, of a relatively low level (approximately <10 dB), which generally vary smoothly with frequency and spatial direction.

Each set of partial HRTFs include their respective features defined above, but preferably not the features related to other perceptual attributes defined within other sets of partial HRTFs. Each set of partial HRTFs includes partial HRTFs with different values of parameters defining these features. For example, the Height partial HRTFs will each include different characteristic features, such as the first pinnae notch positioned at different frequencies or with differing parameters such as the height and width of the notch. The values of the parameters are selected to provide variations in the related perceptual attribute, such as a range of variations in the elevatory position of a virtual sound source rendered using an HRTF comprising those features.

In some examples the partial HRTFs may include incremental variations in important parameters defining the features. For example in the “height” set of partial HRTFs, the partial HRTFs may include periodic variations in the position and/or size of the first pinnae notch. In other examples the partial HRTFs may include common variations of the features as found in measured HRTFs from users, such that the variations included closely match the most common variants of real HRTFs.

As described above, each set of HRTFs comprises certain features of a full HRTF, with those features varied over the set of HRTFs to provide variations in a user-perceived property of an HRTF. In this way a selection from each set may provide the key features of an HRTF related to the perception of a sound source. In order to construct a complete or “full” HRTF, in addition to these important perceptual features in some examples it may be necessary to combine a “baseline” representing the remaining portion of the HRTF, excluding the perceptual features that are included across the sets of partial HRTFs. In particular, the perceptual features included in the partial HRTFs (i.e. the intensity variations with frequency) must be defined relative to a baseline HRTF, that must then be included to synthesise the full HRTF. The baseline may be considered an average response across frequencies, not including the perceptual frequencies, such as the notches. In one example, a baseline HRTF may be determined from measured HRTFs from a plurality of users, by removing all perceptual features (for example-all features known to contribute to localisation perception, such as notches) and averaging across these responses. The perceptual features may then be defined as intensity changes relative to this baseline. The specific form of the baseline HRTF is not important, as long as the features of the partial HRTFs are each defined relative to this baseline and it is added back to form the full HRTF.

In some examples of the invention the partial HRTFs selected from each set of partial HRTFs may be combined together with the baseline HRTF to generate the full HRTF. In particular, the “combining” step, may include performing a multi-way convolution between the partial HRTFs and the baseline HRTFs. In other preferable examples, the baseline may simply be combined with the partial HRTFs of one set of partial HRTFs. To illustrate, in the above example, the baseline may be included with “width” set of partial HRTFs. In this way, a convolution between partial HRTFs selected from each set provides a full, functional HRTF.

The above specific example provides two sets of partial HRTFs defining localisation perception attributes (height and width) and a third defining timbre perception-the component of the transfer function controlling user perception of the “colour” of the sound, that varies between users. The selection of a specific timbre component is optional and, in some examples, the sets of partial HRTF may define only localisation perception features. An average timbre component may be included as part of the baseline such that the method involves only selecting localisation related features. However, including variations in the timbre component can provide better personalisation of the synthesised HRTF, creating more realistic, accurate sounds using a synthesised HRTF. HRTF timbre, the timbre component of a HRTF, is defined as the inter-subject variations of HRTFs that are not related to changes in localization perception. This can be thought of as the notchless magnitude deviation from an average response (i.e. the baseline).

The timbre component may be extracted from a measured HRTF by processing it to remove the spectral notches from the magnitude response of each measurement. This process includes identifying notch boundaries, removing the necessary samples, re-interpolating the response and smoothing the output. If starting from a full HRTF encoding the ITD, the HRTF is initially processed to remove these features, which are key components of the localisation perception features. This process involves removing phase information to remove ITD and preferably applying loudness normalisation. The process then involves subtracting the baseline from this processed HRTF with the localisation related features removed. The baseline may be provided by an average HRTF' across a plurality of users, where an HRTF' comprises a user's HRTF with the localisation perception features removed (i.e. the spectral notches and ITD and ILD) The timbre can be considered the remaining user-dependent variations in the magnitude with frequency, once the height and width localisation features are removed. In this method the set of timbre HRTFs may comprise measured timbre components from users or synthesised timbre components, i.e. HRTFs comprising smoothly varying magnitude changes of less than 10 dB with different forms.

### Storage and Synthesis at Run Time

The present invention may be implemented by storing each set of partial HRTFs in a memory, selecting by user selection or otherwise a partial HRTF from each set and combining these to form a full HRTF which is then used to render binaural audio. Although the present method allows for a large number of HRTF variations based on a relatively small amount of stored data, storing multiple variations of each type of partial HRTF still requires a significant amount of memory. Therefore a number of further steps can be taken to compress the partial HRTF data when storing to reduce the memory requirement.

Firstly the HRTF data may be stored as minimum phase filters in the time domain, i.e. as impulse response (IR) data. This allows the file size to be reduced from the number of samples required to represent the function in the frequency domain. Furthermore, the trailing zeros may be removed from the IR data to reduce the number of samples required to represent an IR further. As a comparison, whereas 512 complex values (1024 values in total) may be required to represent an HRTF at a particular measurement angle in the frequency domain, storing as minimum phase in the time domain requires only real type data, with the trailing zeros trimmed to store the HRTF as HRIR data with fewer than 128 magnitude values. By using these techniques different types of partial HRTF may be stored with different sample sizes so as to store the partial HRTFs with the minimum data size. The trailing zeros can be reapplied up to the original sample length when converting the stored HRIR data back to HRTF data.

Further steps can be taken to compress the data further. In particular, due to the substantially symmetrical data for left and right ears for the height and width partial HRFTs, these may be stored as left side only with the data copied and flipped to provide the right ear at run time.

A process of selecting the partial HRTFs compressed in this way and combining to provide the synthesised HRFT is shown in FIG. 4. The partial HRTFs in each set of partial HRTFs are stored as HRIRs in the time domain. A width HRIR 401 is selected from the width set of partial HRFTs (stored as HRIRs), a height HRIR 402 is selected from the “height” set of partial HRFTs (stored as HRIRs), and a timbre HRIR 403 is selected from the timbre partial HRFTs (stored as HRIRs). The width and height HRTFs are further compressed by storing only the left side. Therefore, the width and height HRIRs are first copied and flipped to provide the right side portion. These components are then combined using a convolution. This can be performed in the frequency or time domain. In one example, the data is stored in the time domain for improved compression and combined in the time domain, before performing an FFT to convert back to the frequency domain and provide an output HRTF that may be used to render binaural audio for the user. Alternatively, after copying and flipping the heigh and width HRIR data, each of the width, height and timbre components may be brought into the frequency domain, multiplied together and then an inverse FFT performed on the result.

In some examples, the method may further comprise storing meta data, wherein the meta data is used with the selected partial HRTF data to construct the full

HRTF. For example, the method may include storing a plurality of variations of meta data, wherein one version of the meta data is selected to construct the HRTFs. One example of this is for the case of the “width” set of partial HRTFs. In this case, each partial HRTF in the set may be stored with a different variation of the accompanying meta data. The meta data may define additional features, such as phase related features to be used when constructing the full HRTF from the minimum phase filters. For example, for the width set of partial HRTFs a corresponding number of variations of meta data defining the ITD is stored and used to construct the full HRTF.

In one example, where the data is stored as minimum phase such that it does not include ITD, the meta data is used to reconstruct the time delay between the left and right ears. In particular the meta data may comprise the ITD to be added to the synthesised HRTF. The meta data may be stored, for example, within the width partial HRTF data, so that when a partial HRTF is selected from the “width” set of partial HRTFs the corresponding meta data encoding the ITD is also selected. The time delay can be directly inserted in the output filters providing the snthesise HRTF, or passed to the binaural renderer to combine during runtime.

The selection of each partial HRTF from the HRTF sets may be made in a number of different ways to allow a user to select an HRTF that provides desirable result. This may involve synthesising an HRTF that is as close as possible to a user's true HRTF to provide the best experience when rendering 3D audio. The partial HRTFs are therefore preferably selected so that the features within the partial HRTF most closely match the user's true HRTF. In one example, a user interface may be provided which allows a user to select between the possible options in each set of partial HRTFs. In one example, the method may involve rendering an output audio signal using an HRTF generated from the selected partial HRTFs to facilitate the selection. For example, a sound may be output from a displayed location and the user may select partial HRTFs that provide the most accurate perception of the expected localisation of the sound source (as well as their preferred timbre characteristics). For example a user interface may be provided allowing a user to adjust the selection of each of the (for example) three sets of partial HRTFs. This could be done with the roll, tilt and yaw of a controller, or by adjusting sliders on a user interface.

In other examples, the user may input data and the selection is made automatically on the basis of the input data. For example the user may input measurements of their HRTF and the partial HRTFs are selected that most closely match the user's HRTF features interpreted from the measurements. The input data may not necessarily be a full measurement of a user's HRTF. The selection could be carried out based on partial measurements of the user's HRTF. In another example the input data may be user physiological data, for example data encoding measurements of the subject's physiology that determine the form of their HRTF. The partial HRTFs required could be predicted based on the input physiological data, for example by a machine learning model trained on training data sets comprising user physiological measurements and HRTF measurements. The physiological data could comprise one or more of data encoding measurements of the user's head size or shape; data encoding measurements of the user's shoulder size or shape; data encoding measurements of the user's torso size or shape; data encoding measurements of the user's ear size or shape; an image of the subject's ears.

The methods of the present invention may be implemented on a video gaming system. In particular the sets of partial HRTFs may be stored in a memory of the video gaming system. The memory may be local or remote. The video gaming system may further comprise a processor configured to select a partial HRTF from each set of partial HRTFs; combine the selected partial HRTF to synthesise a HRTF; and apply the synthesised HRTF to generate binaural audio

1. A computer-implemented method of synthesising a head related transfer function, HRTF, the method comprising:
storing a plurality of sets of partial HRTFs, a partial HRTF comprising a sub-selection of total features of a full HRTF, wherein each set of partial HRTFs comprises variations in a different feature of an HRTF;
selecting a partial HRTF from each set of partial HRTFs;
combining the selected partial HRTFs to generate a synthesized HRTF;
applying the synthesized HRTF to generate binaural audio.

2. The computer-implemented method of claim 1, wherein the variations in the feature across a set of partial HRTFs provides variations in a user perceived property of a sound, with each set of partial HRTFs providing variations in a different user perceived property of sound.

3. The computer-implemented method of claim 1, wherein the method is applied to generate the synthesized HRTF at run-time of a video gaming system, the method comprising:
storing the plurality of sets of partial HRTFs in a memory of a video gaming system;
at run-time, selecting the partial HRTFs and combining to generate the synthesized HRTF; and
applying the synthesized HRTF to generate binaural audio during gameplay of a video gaming system.

4. The computer-implemented method of claim 1, wherein together the combined partial HRTFs selected from each set provide all features of a full HRTF, such that combining selected partial HRTFs synthesizes a full HRTF.

5. The computer-implemented method of claim 1, wherein one or more sets of partial HRTFs correspond to a variation in a parameter associated with a perceived location of a sound source.

6. The computer-implemented method of claim 1, wherein the plurality of sets of partial HRTFs comprise:
a first set of partial HRTFs comprising variations in one or more features of the HRTF associated with perception of a elevatory location of a sound source;
a second set of partial HRTFs comprising variations in one or more features of the HRTF associated with perception of lateral location of a sound source.

7. The computer-implemented method of claim 6, wherein:
the first set of partial HRTFs comprises variations in one or more of: a parameter of a pinnae notch, a parameter associated with contralateral and ipsilateral frequency filtering; and
the second set of partial HRTFs comprise variations in one or both of: an interaural time delay and an interaural level difference.

8. The computer-implemented method of claim 6, wherein the first set of partial HRTFs and second set of partial HRTFs comprise HRTF data for a single ear only, wherein the method comprises: after selecting the partial HRTFs from the first set and the second set, copying the selected partial HRTFs, and using the selected partial HRTFs to provide HRTF data for the second ear.

9. The computer-implemented method of claim 8 comprising:
combining the partial HRTFs selected from the first set and the second set;
adjusting the azimuthal angle of the combined HRTFs to synthesise an HRTF for the second ear.

10. The computer-implemented method of claim 1, wherein the plurality of sets of partial HRTFs comprise:
a set of partial HRTFs comprising variations in a feature of the HRTF associated with a timbre of a sound; and
the partial HRTFs of the set of partial HRTFs each comprise an HRTF with the localisation perception features of the HRTF removed.

11. The computer-implemented method of claim 1, wherein each set of partial HRTFs comprises one or more features that are varied across the set of partial HRTFs to provide variations in a user perceived property of a sound, wherein each of the partial HRTFs of one of the sets of partial HRTFs additionally comprises a baseline HRTF.

12. The computer-implemented method of claim 1, wherein the method comprises selecting a partial HRTF from each set of partial HRTFs at run-time, and performing a convolution of the partial HRTFs to combine them to form the full HRTF.

13. The computer-implemented method of claim 1, wherein the method comprises storing each partial HRTF as head related impulse response, HRIR, data in a time domain.

14. The computer-implemented method of claim 13, wherein the method comprises storing each partial HRTF as a minimum phase filter in the time domain, and truncating trailing zeros from each minimum phase filter.

15. The computer-implemented method of claim 13, wherein combining the selected partial HRTFs comprises converting the HRIR data into a frequency domain and performing a convolution of each partial HRTF.

16. The computer implemented method of claim 1, wherein selecting the partial HRTF from each set of partial HRTFs comprises:
receiving a user input and performing the selection based on the user input.

17. The computer implemented method of claim 16, wherein the method comprises receiving user input of measurement data encoding a measurement of at least part of the user's HRTF and selecting the partial HRTFs based on the measurement data.

18. The computer implemented method of claim 16, wherein selecting the partial HRTFs comprises:
receiving user physiological data and selecting the partial HRTFs based on the received user physiological data; wherein physiological data comprises one or more of:
data encoding measurements of the user's head size or shape;
data encoding measurements of the user's shoulder size or shape;
data encoding measurements of the user's torso size or shape;
data encoding measurements of the user's ear size or shape;
an image of the user's ears; and
selecting the partial HRTFs based on the received user physiological data comprises inputting the physiological data into a machine learning model trained to map the physiological data to a stored partial HRTF.

19. A non-transitory computer program comprising instructions that, when executed by a computer, cause the computer to perform a method according to claim 1.

20. A video gaming system comprising:
a memory storing a plurality of sets of partial HRTFs, a partial HRTF comprising a sub-selection of total features of a full HRTF, wherein each set of partial HRTFs comprises variations in a different feature of an HRTF; and
a processor configured to:
select a partial HRTF from each set of partial HRTFs;
combine the selected partial HRTFs to generate a synthesized HRTF;
apply the synthesized HRTF to generate binaural audio.
